(19) United States
(12) Patent Application Publication
(10) Pub. No.: US 2023/0205374 A1
(43) Pub. Date: Jun. 29, 2023

(54) TOUCH PANEL AND TOUCH DISPLAY DEVICE

(71) Applicant: HONG FU JIN PRECISION INDUSTRY (ShenZhen) CO., LTD., Shenzhen (CN)

(72) Inventors: CHING-YU CHOU, New Taipei (TW); GUAN NONG, Shenzhen (CN)

(21) Appl. No.: 18/118,451

(22) Filed: Mar. 7, 2023

Related U.S. Application Data
(63) Continuation of application No. 16/891,662, filed on Jun. 3, 2020.

(30) Foreign Application Priority Data
Jan. 17, 2020 (CN) 202020118126.X

(51) Int. Cl. G06F 3/044

(52) U.S. Cl. CPC G06F 3/0443; G06F 2203/04103; G06F 2203/04107

(57) ABSTRACT

A touch panel and a touch display device using the touch panel are disclosed. The touch panel defines a touch area and a border area surrounding the touch area. The touch panel includes a substrate, a light-shielding layer, and a touch layer. The substrate has opposite first and second surfaces. The light-shielding layer is on the first surface and in the border area. The touch layer is on the second surface, and the touch layer is configured to sense user touches.

### FIELD

The subject matter herein generally relates to touch displays, specifically a touch panel and a touch display device using the touch panel.

### BACKGROUND

FIG. 6 shows a touch panel 1 of related art. The touch panel 1 includes a first substrate 2, a light-shielding layer 3, an adhesive layer 4, a second substrate 5, and a touch layer 6 stacked in said sequence. Positions of the second substrate 5 and the touch layer 6 may be interchanged in other embodiments. A method for making the touch panel 1 includes first forming the light-shielding layer 3 on the first substrate 2, then forming the touch layer 6 on the second substrate 5. The method further includes a bonding process for bonding the first substrate 2 and the second substrate 5, the method is too complicated.

Therefore, there is room for improvement in the art.

### BRIEF DESCRIPTION OF THE DRAWINGS

Implementations of the present disclosure will now be described, by way of embodiment, with reference to the attached figures.

FIG. 1 is a plan view of a touch panel according to a first embodiment.

FIG. 2 is a cross-sectional view along line II-II of FIG. 1.

FIG. 3 is a cross-sectional view of a touch panel according to a second embodiment.

FIG. 4 is a cross-sectional view of a protective layer of the touch panel according to an embodiment.

FIG. 5 is a schematic view of a touch display device according to an embodiment.

FIG. 6 is a cross-sectional view of a touch panel according to related art.

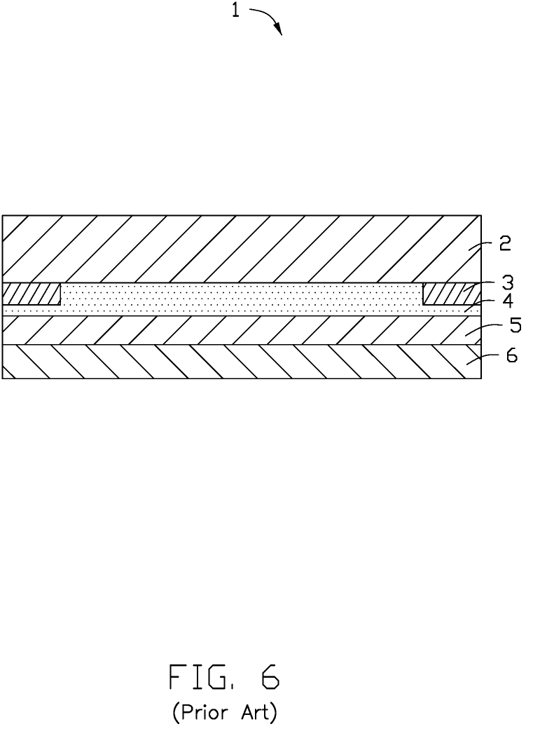

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

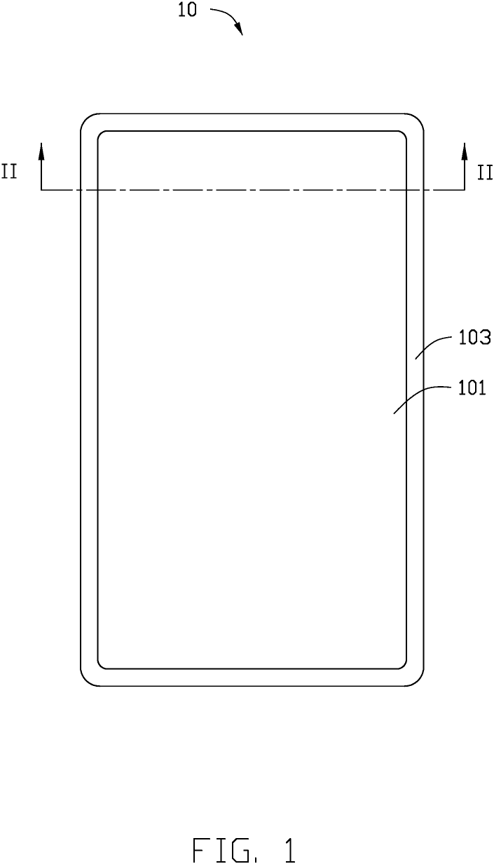

FIG. 1 shows a touch panel 10 according to a first embodiment. The touch panel 10 defines a touch area 101 and a border area 103 surrounding the touch area 101. The border area 103 has wiring.

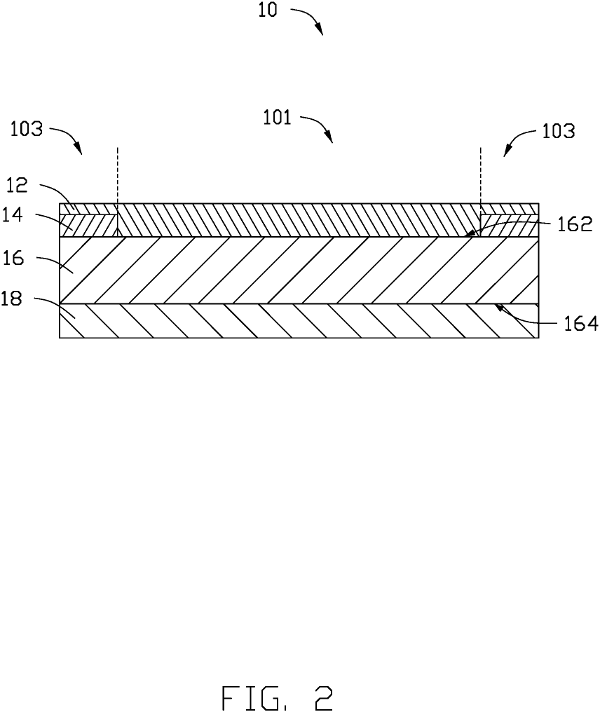

As shown in FIG. 2, the touch panel 10 includes a substrate 16, a light-shielding layer 14, and a touch layer 18. The substrate 16 has a first surface 162 and a second surface 164 opposite to the first surface 162. The light-shielding layer 14 is on the first surface 162 of the substrate 16 and aligned with the border area 103. The touch layer 18 is on the second surface 164 of the substrate 16. The touch layer 18 is configured to sense user touches. The light-shielding layer 14 covers the entire border area 103. In other embodiments, the light-shielding layer 14 covers only part of the border area 103.

The light-shielding layer 14 and the touch layer 18 are on opposite surfaces of one substrate, thus a bonding of two substrates is not required. The method for making the touch panel 10 is simplified. In addition, compared with the touch panel 1, one layer of substrate and the adhesive layer between two substrates are not present. The material cost and processing cost are reduced, a thickness and weight of the touch panel 10 are reduced, and the touch panel 10 is thinner and lighter.

In one embodiment, the substrate 16 may be made of transparent plates or films, such as polycarbonate (PC), polymethyl methacrylate (PMMA), PC/PMMA composite sheet, PC/PMMA/PC three-layer composite sheet, polyethylene terephthalate (PET), polystyrene (PS), polyvinyl chloride (PVC), polypropylene (PP), or glass. In other embodiments, the substrate 16 may be made of opaque plates or films, such as acrylonitrile butadiene styrene (ABS).

In one embodiment, the touch layer 18 includes a plurality of touch driving electrodes (not shown) spaced apart from each other and a plurality of touch sensing electrodes (not shown) spaced apart from each other. The touch driving electrodes and the touch sensing electrodes form a touch sensing structure. When a conductive object (e.g., a fingertip) touches a certain point of the touch panel 10, a coupling capacitance between the touch driving electrodes and the touch sensing electrodes near the touch point changes, resulting in changes in mutual capacitance. Signals therefor (e.g., voltage value) change accordingly. By processing and calculating the change of the mutual capacitance, coordinates of the touch point can be determined.

In one embodiment, each of the touch driving electrodes and each of the touch sensing electrodes have a shape of rhombus. The touch driving electrodes are arranged in a plurality of rows and in a plurality of columns. Each row extends in a first direction, and each column extends in a second direction. The first direction intersects with the second direction. The touch driving electrodes in each row are electrically connected one by one to form a string of touch driving electrodes. Any two touch driving electrodes in different rows are electrically insulated from each other. The touch sensing electrodes are arranged in a plurality of rows and in a plurality of columns. The touch sensing electrodes in each column are electrically connected one by one to form a string of touch sensing electrodes. Any two touch sensing electrodes in different columns are electrically insulated from each other. Each string of touch driving electrodes extending in the first direction and each string of touch sensing electrodes extending in the second direction intersect with each other.

In one embodiment, along a thickness direction of the substrate 16, a projection of each string of touch driving electrodes is between adjacent strings of touch sensing electrodes, and a projection of each string of touch sensing electrodes is between adjacent strings of touch driving electrodes.

In another embodiment, the touch layer 18 includes a plurality of touch electrodes (not shown) spaced apart from each other. The touch electrodes form a single-layer self-capacitive touch sensing structure. When a conductive object (e.g., a fingertip) touches a certain point of the touch panel 10, a self-capacitance of the touch electrode changes. By processing and calculating the changes of self-capacitance, coordinates of the touch point can be determined.

In one embodiment, the touch layer 18 can transmit light. The touch layer 18 may be made of graphene, carbon nanotube, metal nanowire, indium tin oxide (ITO), metal mesh, or other conductive materials. In one embodiment, a conductive layer is formed on the substrate 16 by magnetron sputtering, vacuum evaporation, printing, coating, etc., and then the touch layer 18 is formed by patterning the conductive layer using a photolithography process.

In one embodiment, the light-shielding layer 14 may be made of white or black light-shielding ink. The light-shielding layer 14 may be formed on the first surface 162 of the substrate 16 by printing or a photolithography process, and the light-shielding material may be cured by ultraviolet (UV) irradiation or heating and baking. The printing process may be, but is not limited to, screen printing.

As shown in FIG. 2, the touch panel 10 further includes a protective layer 12 on a side of the light-shielding layer 14 away from the substrate 16. The protective layer 12 prevents the light-shielding layer 14 from being scratched. The protective layer 12 covers the first surface 162 of the substrate 16 and a surface of the light-shielding layer 14 away from the substrate 16. In one embodiment, the protective layer 12 creates a planar surface for receiving touches. In one embodiment, the protective layer 12 is in direct contact with the first surface 162 of the substrate 16 and the surface of the light-shielding layer 14 away from the substrate 16.

In one embodiment, the protective layer 12 may be formed on the first surface 162 of the substrate 16 and the light-shielding layer 14 by using a coating method such as dispensing, screen printing, roll coating, spray coating, and flow coating, or an imprint method. The surface of the protective layer 12 formed by the imprint process has protrusions, recesses, or such surface textures as including, but not limited to, wire drawing on the surface away from the substrate 16, to change glossiness and mirror-finish of the protective layer 12.

In one embodiment, the protective layer 12 has an anti-glare function, an anti-fingerprint function, an anti-reflection function, or an anti-fogging function. A material of the protective layer 12 may be a UV-curable coating, a heat-curable coating, or a moisture-curable coating. The UV-curable coating may be, but is not limited to, an acrylate resin or oligomer coating or an epoxy resin coating. The heat-curable coating may be, but is not limited to, a polyurethane resin coating.

In one embodiment, the protective layer 12 is a UV-curable coating, and the protective layer 12 includes, but is not limited to, oligomers, reactive diluents, solvents, photo initiators, and other additives. A reference formula is: oligomer etercure 6047 is 35.0 in weight percent (wt%), reactive diluent trimethylolpropane triacrylate is 10.0 wt%, reactive diluent 1,6-hexanediol diacrylate is 10.0 wt%, photo initiator irgacure 184 is 2.5 wt%, solvent isopropanol is 14.2 wt%, solvent methyl isoamyl ketone (MIAK) is 28.1 wt%, and additive BYK 333 is 0.2 wt%.

In one embodiment, a method for making the touch panel 10 may include one or more of the following steps: the touch layer 18 is formed on the second surface 164 of the substrate 16; the light shielding layer 14 is formed on the first surface 162 of the substrate 16; then the protective layer 12 is formed on the light shielding layer 14 and the first surface 162 of the substrate 16.

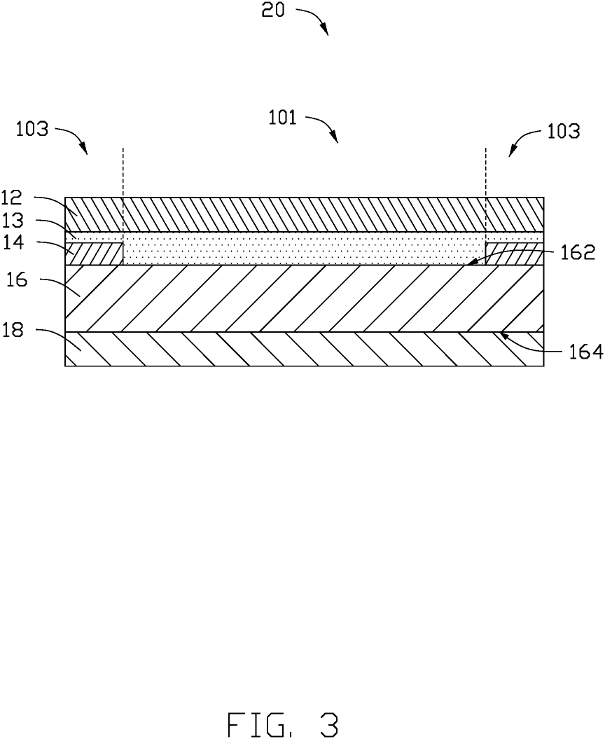

FIG. 3 shows a touch panel 20 according to a second embodiment. The difference between the touch panel 20 of the second embodiment and the touch panel 10 of the first embodiment is that the touch panel 20 further includes an adhesive layer 13. The adhesive layer 13 is in the touch area 101 and between the substrate 16 and the protective layer 12 to bond the substrate 16 and the protective layer 12. The adhesive layer 13 is also in the border area 103 and between the light-shielding layer 14 and the protective layer 12 to bond the light-shielding layer 14 and the protective layer 12.

In one embodiment, the adhesive layer 13 may be a pressure-sensitive adhesive or curable liquid glue. The pressure-sensitive adhesive includes, but is not limited to, an optically-clear adhesive (OCA) which is pressure sensitive. The liquid glue is formed on the light-shielding layer 14 and the first surface 162 of the substrate 16 by a dispensing method such as dispensing by a dispenser, roll coating, spray coating, flow coating, or screen printing. A material of the adhesive layer 13 may be a UV-curable acrylate system adhesive, a UV-curable epoxy system adhesive, or a heat-curable adhesive.

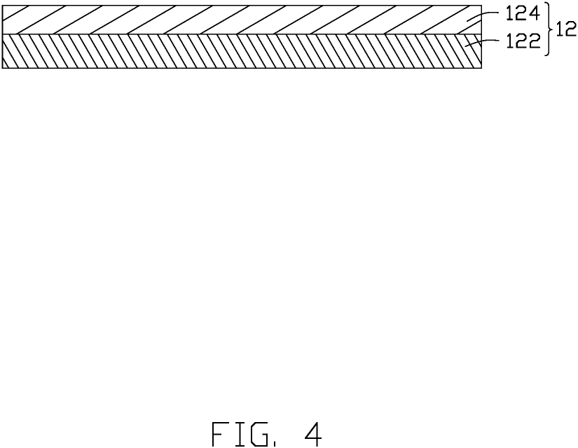

In one embodiment, as shown in FIG. 4, the protective layer 12 includes a film layer 122 and a coating layer 124 on the film layer 122.

In an embodiment, the film layer 122 may be made of transparent plates or films, such as PC, PMMA, PC/PMMA composite sheet, PC/PMMA/PC three-layer composite sheet, PET, PS, PVC, PP, or glass. In other embodiments, the film layer 122 may be made of opaque plates or films, such as ABS.

In one embodiment, a material of the coating layer 124 may be a UV-curable coating, a heat-curable coating, or a moisture-curable coating.

The UV-curable coating may be, but is not limited to, an acrylate resin or oligomer coating or an epoxy resin coating. The heat-curable coating may be, but is not limited to, a polyurethane resin coating.

The coating layer 124 may be formed on a surface of the film layer 122 by using coating methods such as dispensing, roll coating, spray coating, and flow coating, or an imprint method. The surface of the coating layer 124 formed by the imprint process has protrusions, concave holes, or surface textures including, but not limited to, wire drawing on the surface away from the film layer 122, to change the gloss of the protective layer 12.

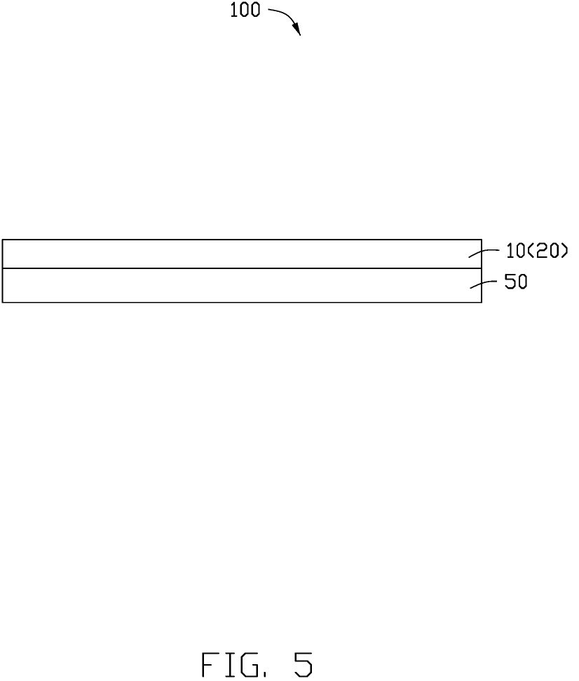

FIG. 5 shows a touch display device 100 according to an embodiment. The touch display device 100 includes a display panel 50 and the touch panel 10 (20) on a side of the display panel 50.

In one embodiment, the display panel 30 may be a liquid crystal display panel, a micro light-emitting diode (LED)display panel, or an organic light-emitting diode (OLED)display panel. The touch display device 100 may be a smart phone, a tablet computer, or the like.

In the touch display device 100, the light-shielding layer 14 and the touch layer 18 included in the touch panel 10 (20) are on opposite surfaces of the substrate 16. Compared to a touch panel in which the light shielding layer and the touch layer are formed on different substrates, the touch panel 10 (20) does not need two substrates, the alignment and bonding process of the two substrates are reduced, and the method for making the touch panel 10 (20) is simplified.

In addition, compared with a conventional touch panel, a layer of substrate and an adhesive layer for bonding the two different substrates are omitted. The material cost and processing cost are reduced, and the thickness and weight of the touch panel 10 (20) are reduced. The touch display device 100 using the touch panel 10 (20) is thinner and lighter.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch panel defining a touch area and a border area surrounding the touch area, comprising:
a substrate having a first surface and a second surface opposite to the first surface;
a light-shielding layer on the first surface and in the border area;
a touch layer on the second surface and configured to sense user touches; and
a protective layer on a side of the light-shielding layer away from the substrate and configured to prevent the light-shielding layer from being scratched;
wherein the protective layer is in direct contact with both an area of the first surface of the substrate in the touch area and a surface of the light-shielding layer away from the substrate, and the protective layer creates a planar surface for receiving touches.

2. The touch panel according to claim 1, wherein the protective layer has an anti-glare function, an anti-fingerprint function, an anti-reflection function, or an anti-fogging function.

3. The touch panel according to claim 1, wherein a material of the protective layer is an UV-curable coating, a heat-curable coating, or a moisture-curable coating.

4. The touch panel according to claim 3, wherein the UV-curable coating comprises an acrylate resin or oligomer coating or an epoxy resin coating, and the heat-curable coating comprises a polyurethane resin coating.

5. The touch panel according to claim 1, wherein a surface of the protective layer away from the substrate has protrusions, recesses, or brushed textures.

6. A touch display device, comprising a display panel for displaying images and a touch panel on a side of the display panel, the touch panel defining a touch area and a border area surrounding the touch area, the touch panel comprising:
a substrate having a first surface and a second surface opposite to the first surface;
a light-shielding layer on the first surface and in the border area;
a touch layer on the second surface and configured to sense user touches; and
a protective layer on a side of the light-shielding layer away from the substrate and configured to prevent the light-shielding layer from being scratched;
wherein the protective layer is in direct contact with both an area of the first surface of the substrate in the touch area and a surface of the light-shielding layer away from the substrate, and the protective layer creates a planar surface for receiving touches.

7. The touch display device according to claim 6, wherein the protective layer has an anti-glare function, an anti-fingerprint function, an anti-reflection function, or an anti-fogging function.

8. The touch display device according to claim 6, wherein a material of the protective layer is an UV-curable coating, a heat-curable coating, or a moisture-curable coating.

9. The touch display device according to claim 8, wherein the UV-curable coating comprises an acrylate resin or oligomer coating or an epoxy resin coating, and the heat-curable coating comprises a polyurethane resin coating.

10. The touch display device according to claim 6, wherein a surface of the protective layer away from the substrate has protrusions, recesses, or brushed textures.
